(19) United States
(12) Patent Application Publication
(10) Pub. No.: US 2024/0211792 A1
(43) Pub. Date: Jun. 27, 2024

(54) DETECTING LEAKAGE ERRORS IN HYPERFINE QUBITS

(71) Applicant: Quantinuum LLC, Broomfield, CO (US)

(72) Inventors: John Gaebler, Golden, CO (US); Anthony Ransford, Broomfield, CO (US); Lucas Sletten, Robbinsdale, MN (US); Fangzhao An, St. Louis Park, MN (US); James Hostetter, Eagan, MN (US); Andrew Schaffer, Chanhassen, MN (US); Grahame Vittorini, St. Louis Park, MN (US)

(21) Appl. No.: 18/514,279

(22) Filed: Nov. 20, 2023

Related U.S. Application Data
(60) Provisional application No. 63/476,418, filed on Dec. 21, 2022.

(51) Int. Cl. G06N 10/70; G06F 11/07

(52) U.S. Cl. CPC G06N 10/70; G06F 11/079

(57) ABSTRACT

Various embodiments relate to detecting leakage errors in a quantum system. A controller of the quantum system causes a first manipulation source to provide a first manipulation signal to a particular region of an apparatus of the quantum system having one or more atomic objects therein. The first manipulation signal is tuned to excite the one or more atomic objects within the particular region that are in a qubit space of a ground state manifold to a shelving manifold and to suppress excitation of atomic objects within the particular region that have leaked out of the qubit space into leaked states. The controller causes a second manipulation source to provide a second manipulation signal to perform a detection operation on the one or more atomic objects. The controller determines if leakage errors have occurred based on a signal generated as part of the detection operation.

### CROSS-REFERENCE TO RELATED APPLICATIONS

This application claims priority to U.S. Application No. 63/476,418, filed Dec. 21, 2022, the content of which is incorporated herein by reference in its entirety.

### TECHNICAL FIELD

Various embodiments relate to detecting leakage errors in a trapped atomic object quantum computer. For example, various embodiments relate to detecting leakage errors in hyperfine qubits.

### BACKGROUND

In trapped atomic object quantum computers, trapped atomic objects (e.g., atoms, ions, and/or the like) are used as qubits of the quantum computer. Qubits, similar to classical bits, may be in one of two states (e.g., 0 or 1). However, atomic objects within a trap may be in more than two states. When an atomic object leaves the defined two state qubit space, the atomic object is said to have been leaked. This leakage leads to leakage errors. Through applied effort, ingenuity, and innovation many deficiencies of such systems have been solved by developing solutions to detect the leakage errors that are structured in accordance with the embodiments of the present invention, many examples of which are described in detail herein.

### BRIEF SUMMARY OF EXAMPLE EMBODIMENTS

Example embodiments provide quantum computers, systems, apparatuses, and/or the like and corresponding methods for performing a leakage errors detection operation. In various embodiments, the leakage errors detection operation may be performed while qubit levels are shelved and protected to reduce shelving errors and maintain high fidelities of a quantum computer. Various embodiments provide quantum computers, systems, apparatuses, and/or the like and corresponding methods for performing a qubit reading and/or detection operation that results in determination of the quantum state of the qubit being one of a leaked state, a first qubit state, or a second qubit state.

In various embodiments, a two-state qubit space is defined. In various embodiments, a qubit is an atomic object contained, trapped, and/or otherwise within an apparatus of a quantum computer. The atomic object contained, trapped, and/or otherwise within the apparatus 50 may have access to more states than those of the qubit space. For example, when the atomic object is a nuclear-spin 3/2 atomic object, the ground state manifold of the atomic object may comprise eight states (e.g., two states in the qubit space and six leaked states). Thus, as the quantum computer executes various operations, one or more atomic objects trapped in the apparatus may be leaked into a leaked state. The leakage of atomic objects into leaked states results in errors in the computations performed by the quantum computer. Various embodiments provide techniques and corresponding apparatus and/or systems for detecting the leakage errors while shelving and protecting qubit levels. In particular, both hyperfine qubit levels of the ground level may be excited and shelved to long-lived meta-stable states of a shelving manifold that do not participate in the detection cycle and population in the non-qubit levels are not affected by the shelving. In various embodiments, laser beams are turned on to cause atomic objects at leakage states to fluoresce and a presence of the fluoresce indicates leaked errors occurred. In various embodiments, the shelved qubit state may be de-shelved and coupled to a ground state manifold or an intermediary state manifold. Detection operation may be performed to determine qubit states of the atomic objects. As such, the leakage error detection can be achieved without affecting the ability to determine qubit state. In addition, shelving errors are minimized and high fidelities are achieved with the use of multiple shelving and de-shelving pulses.

According to an aspect of the present disclosure, a method for detecting leakage errors in a quantum system is provided. In an example embodiment, the method includes causing, by a controller of the quantum system, a first manipulation source to provide a first manipulation signal to a particular region of an apparatus of the quantum system having one or more atomic objects therein. The first manipulation signal is tuned to excite the one or more atomic objects within the particular region of the apparatus that are in a qubit space of a ground state manifold to a shelving manifold and to suppress excitation of atomic objects within the particular region of the apparatus that have leaked out of the qubit space to form leaked states. The method further comprises causing, by the controller of the quantum system, a second manipulation source to provide a second manipulation signal to perform a detection operation on the one or more atomic objects; and determining, by the controller of the quantum system, whether leakage errors have occurred based on a signal of the detection operation.

In an example embodiment, the first manipulation signal includes at least two shelving pulses to excite the one or more atomic objects within the particular region of the apparatus that are in the qubit space to the shelving manifold.

In an example embodiment, the first manipulation signal further includes a microwave pulse to couple qubit states within the qubit space.

In an example embodiment, the qubit space of the ground state manifold includes a first qubit state and a second qubit state.

In an example embodiment, in response to the leakage errors not being detected, the method further comprises: causing, by the controller of the quantum system, a third manipulation source to provide a third manipulation signal to the particular region of the apparatus, wherein the third manipulation signal is tuned to de-shelve the first qubit state from the shelving manifold to the ground state manifold or an intermediary state manifold.

In an example embodiment, the controller of the quantum system is further configured to determine if the one or more atomic objects are in the first qubit states in the ground state manifold or the intermediary state manifold based on a signal of the detection operation.

In an example embodiment, the controller of the quantum system is further configured to determine if the one or more atomic objects are in the second qubit states in the shelving manifold based on a signal of the detection operation.

In an example embodiment, the one or more atomic objects are nuclear-spin 3/2 atomic objects, the ground state manifold is a ²P_{1/2} manifold, the intermediary state manifold is a ²D_{3/2} manifold, and the shelving manifold is a ²D_{5/2} manifold.

In an example embodiment, the qubit space is defined based on hyperfine structure of a ground state manifold of the one or more atomic objects.

In an example embodiment, each of the one or more atomic objects has a spin 3/2 nucleus.

According to another aspect, a quantum system for performing a leakage errors detection operation is provided. In an example embodiment, the quantum system comprises an apparatus having one or more atomic objects therein; a first manipulation source configured to provide a first manipulation signal; a second manipulation source configured to provide a second manipulation signal; and a controller. The controller is configured to cause the first manipulation source to provide the first manipulation signal to a particular region of an apparatus of the quantum system having the one or more atomic objects therein, The first manipulation signal is tuned to excite the one or more atomic objects within the particular region of the apparatus that are in a qubit space of a ground state manifold to a shelving manifold and to suppress excitation of atomic objects within the particular region of the apparatus that have leaked out of the qubit space to form leaked states. The controller is further configured to cause the second manipulation source to provide the second manipulation signal to perform a detection operation on the one or more atomic objects; and determine if leakage errors have occurred based on a signal of the detection operation.

In an example embodiment, the first manipulation signal includes at least two shelving pulses to excite the one or more atomic objects within the particular region of the apparatus that are in the qubit space to the shelving manifold.

In an example embodiment, the first manipulation signal further includes a microwave pulse to couple qubit states within the qubit space.

In an example embodiment, the qubit space of the ground state manifold includes a first qubit state and a second qubit state.

In an example embodiment, in response to the leakage errors not being detected, the controller is further configured to cause a third manipulation source to provide a third manipulation signal to the particular region of the apparatus, wherein the third manipulation signal is tuned to de-shelve the first qubit state from the shelving manifold to the ground state manifold or an intermediary state manifold.

In an example embodiment, the controller of the quantum system is further configured to determine if the one or more atomic objects are in the first qubit states in the ground state manifold or the intermediary state manifold based on a signal of the detection operation.

In an example embodiment, the controller of the quantum system is further configured to determine if the one or more atomic objects are in the second qubit states in the shelving manifold based on a signal of the detection operation.

In an example embodiment, the one or more atomic objects are nuclear-spin 3/2 atomic objects, the ground state manifold is a ²P_{1/2} manifold, the intermediary state manifold is a ²D_{3/2} manifold, and the shelving manifold is a ₂D_{5/2} manifold.

In an example embodiment, the qubit space is defined based on hyperfine structure of a ground state manifold of the one or more atomic objects.

In an example embodiment, each of the one or more atomic objects has a spin 3/2 nucleus.

According to another aspect, a method is provided. In an example embodiment, the method comprises causing performance of a detection operation on an atomic object; and determining a detected state of the atomic object, wherein the detected state of the atomic object is determined by processing one or more photon detector signals generated during performance of the detection operation and the detected state of the atomic object is determined from the group consisting of leaked state, a first qubit state, and a second qubit state.

In an example embodiment, the method further comprises providing (e.g., to a (classical) computing entity) an indication of the detected state.

According to another aspect, a controller comprising a classical processing device and a classical memory storing executable instructions is provided. The executable instructions are configured to, when executed by the classical processing device, cause the controller to control one or more components of a system comprising a confinement apparatus confining one or more atomic objects to perform a detection operation on an atomic object of the one or more atomic objects; and determine, by processing one or more photon detector signals generated during performance of the detection operation, whether the atomic object is in a leaked state, a first qubit state, or a second qubit state.

According to another aspect, a system is provided. The system comprises a confinement apparatus configured to confine one or more atomic objects; an optics collection system comprising a photon detector; and a controller, wherein the controller is configured to receive photon detector signals generated by the photon detector. The controller comprises a classical processing device and a classical memory storing executable instructions, the executable instructions configured to, when executed by the classical processing device, cause the controller to control one or more components of a system comprising a confinement apparatus confining one or more atomic objects to perform a detection operation on an atomic object of the one or more atomic objects; and determine, by processing one or more photon detector signals generated during performance of the detection operation, whether the atomic object is in a leaked state, a first qubit state, or a second qubit state.

### BRIEF DESCRIPTION OF THE SEVERAL VIEWS OF THE DRAWING(S)

Having thus described the invention in general terms, reference will now be made to the accompanying drawings, which are not necessarily drawn to scale, and where:

FIG. 1 provides block diagram of an example atomic object quantum computer, in accordance with an example embodiment.

FIGS. 2A and 2B each provide a schematic diagram of a step of performing a shelving operation, in accordance with an example embodiment.

FIG. 3 provides a schematic diagram of a step of performing a detection operation, in accordance with an example embodiment.

FIGS. 4A and 4B each provide a schematic diagram of a step of performing a de-shelving operation, in accordance with an example embodiment.

FIG. 5 provides a schematic diagram of a step of performing another detection operation, in accordance with an example embodiment.

FIG. 6 provides a flowchart illustrating various processes and/or procedures, of a detection operation, in accordance with an example embodiment.

FIG. 7 provides a schematic diagram of an example controller of a quantum computer comprising an apparatus having atomic objects therein, in accordance with an example embodiment.

FIG. 8 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

A qubit is a quantum bit, the counterpart in quantum computing to the binary digit or bit of classical computing. Just as a bit is the basic unit of information in a classical computer, a qubit is the basic unit of information in a quantum computer. A qubit is a two-state (or two-level) quantum-mechanical system, one of the simplest quantum systems displaying the peculiarity of quantum mechanics. Examples of two-state quantum-mechanical systems that have been used as qubits include: the spin of the electron or atomic nucleus in which the two levels can be taken as spin up and spin down and the polarization of a single photon in which the two states can be taken to be the vertical polarization and the horizontal polarization.

In various embodiments, hyperfine splitting is the splitting of energy levels of the atomic object due to interaction between the state of the nucleus and the state of the electron clouds of the atomic object. In various embodiments, an atomic object may be an atom or an ion. In an example embodiment, an atomic object is one or more atoms or ions of one or more elements and/or species. As used herein, the term manifold refers to the plurality of states corresponding to a particular primary quantum number and angular momentum quantum number.

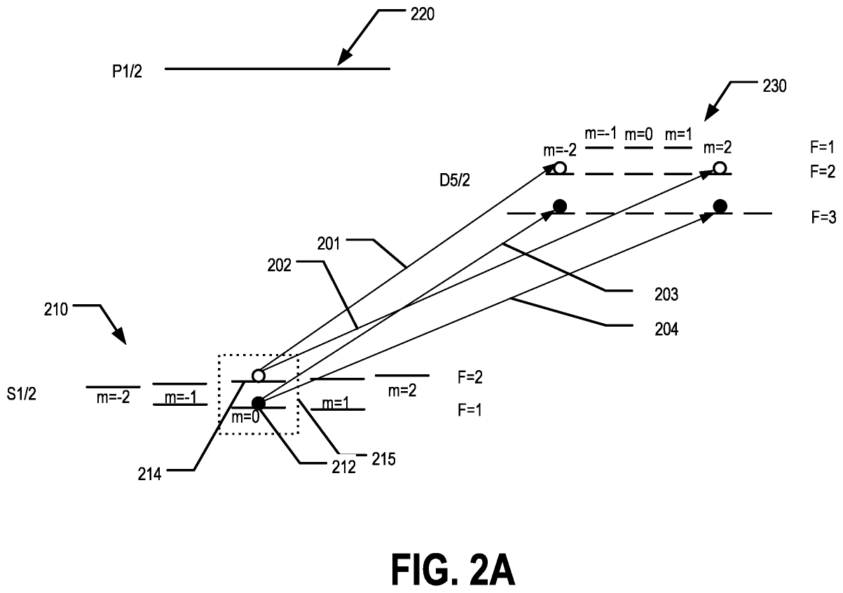

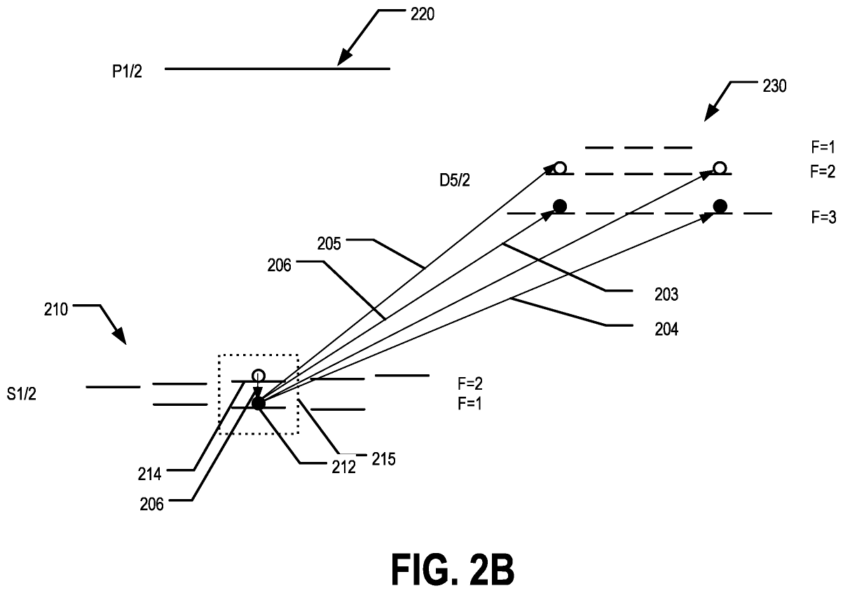

In various quantum-mechanical systems, a two-state qubit space may be defined. For example, a two-state qubit space may be defined as two hyperfine levels of an atomic object. For example, in an atomic object with a spin 3/2 nucleus, such as 137Ba+, and/or the like, two hyperfine levels may be defined as a two-state qubit space 215, as shown in FIG. 2. For example, the two-states may correspond to whether F=1, m=0, ²S_{1/2} state (e.g., the |0>state) is occupied or whether the F=2, m=0, ²S_{1/2} state (e.g., the |1>state) is occupied , where F indicates the total angular momentum of the atomic object (e.g., F is the sum of the nuclear spin and the electron angular momentums of the atomic object). However, the m=0, ²S_{1/2} states are not the only states of the ground level ²S_{1/2} manifold. Thus, it is possible that an atomic object may be leaked from the qubit space 215. For example, rather than being in a first qubit state (e.g., F=2, m=0, ²S_{1/2} state 214, the |1>state) or a second qubit state (e.g., F=1, m=0, ²S_{1/2} state 212, the |0>state), the atomic object may be in the F=1, m=−1 or 1, ²S_{1/2} state or F=2, m=−2, −1, 1, or 2, ²S_{1/2} state. As used herein the quantum number m refers to the z-component of the total angular momentum, for example.

Various embodiments provide techniques and corresponding apparatus and/or systems for detecting leakage errors caused by these leaked atomic objects. Various embodiments provide techniques and corresponding apparatus and/or systems for performing a qubit reading and/or detection operation that results in determination of the quantum state of the qubit being one of a leaked state, a first qubit state, or a second qubit state. For example, various embodiments provide techniques and corresponding apparatus and/or systems for detecting leakage errors while shelving and protecting qubit levels. In particular, both hyperfine qubit levels of the ground level may be excited and shelved to long-lived meta-stable states of a shelving manifold that do not participate in the detection cycle and population in the non-qubit levels are not affected by the shelving. In various embodiments, laser beams are turned on to cause atomic objects at leakage states to fluoresce. For example, laser beams are turn on to cause the atomic objects in the leakage states to transit to excited states and resulting in photons being released when the atomic object decays from the excited states. The fluoresce may be detected by a photon detector. In various embodiments, a presence of the fluoresce indicates leaked errors occurred. In various embodiments, the shelved qubit state may be de-shelved by, for example, coupling the shelved qubit state to one or more states in a ground state manifold or an intermediary state manifold. A detection operation may be performed to determine qubit states of the atomic objects.

### Exemplary Quantum Computer System

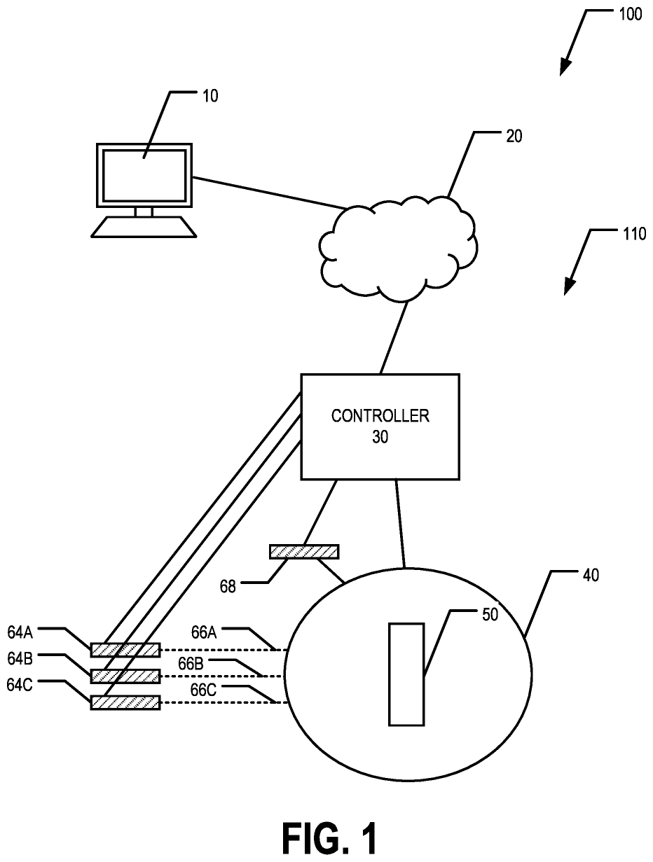

FIG. 1 provides a block diagram of an example quantum computer system 100. In various embodiments, the quantum computer system 100 comprises a computing entity 10 and a quantum computer 110. In various embodiments, the quantum computer 110 comprises a controller 30, a cryogenic and/or vacuum chamber 40 enclosing an apparatus 50 having atomic objects therein, one or more manipulation sources 64 (e.g., 64A, 64B, 64C), and an optics collection system 68. In an example embodiment, the one or more manipulation sources 64 may comprise one or more lasers (e.g., optical lasers, microwave sources and/or masers, and/or the like) or another manipulation source. In various embodiments, the one or more manipulation sources 64 are configured to manipulate and/or cause a controlled quantum state evolution of one or more atomic objects within the apparatus 50. In an example embodiment, an atomic object is one or more atoms or ions of one or more elements and/or species. In an example embodiment, the apparatus 50 is an atomic object trap, ion trap, and/or other apparatus configured to confine, contain, trap, and/or otherwise have atomic objects therein. For example, the apparatus 50 may be a surface ion trap, in an example embodiment. In an example embodiment, where the one or more manipulation sources 64 comprise one or more lasers, the lasers may provide one or more laser beams to the apparatus 50 within the cryogenic and/or vacuum chamber 40. In various embodiments, the manipulation sources 64 may be used to perform gate operations, cooling operations, leakage errors detection operations, and/or the like. In an example embodiment, the one or more manipulation sources 64 each provide a laser beam and/or the like to the apparatus 50 via a corresponding beam path 66 (e.g., 66A, 66B, 66C). In various embodiments, at least one beam path 66 comprises a modulator configured to modulate the manipulation beam being provided to the apparatus 50 via the beam path 66. In various embodiments, the manipulation sources 64, modulator, and/or other components of the quantum computer 110 are controlled by the controller 30.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms, and/or the like into a computing language, executable instructions, command sets, and/or the like that the controller 30 can understand and/or implement.

In various embodiments, the controller 30 is configured to control electrical signal sources and/or drivers controlling the apparatus 50 and/or transport of atomic objects within the apparatus 50, a cryogenic system and/or vacuum system controlling the temperature and pressure within the cryogenic and/or vacuum chamber 40, manipulation sources 60, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more atomic objects within the apparatus 50. In various embodiments, the atomic objects trapped within the apparatus 50 are used as qubits of the quantum computer 110.

In various embodiments, the controller 30 is configured to control a photon detector of the optics collection system 68 to detect the photon emitted by the atomic object and provide a corresponding photon detector signal to the controller 30. The photon detector signal is an electric signal, in various embodiments, with an amplitude that indicates the intensity of light and/or number of photons detected.

### Overview of Leakage Errors Detection Operation

In various embodiments, the atomic objects contained, trapped, and/or otherwise within the apparatus 50 have spin 3/2 nuclei. For example, the atomic objects may be 137Ba+and/or other nuclear-spin 3/2 atomic objects and/or other atomic objects that exhibit states that are appropriate for defining a qubit space. Various atomic objects having various nuclear spins may be used in various embodiments. FIGS. 2A and 2B provide schematic diagrams of the S_{1/2} and D_{5/2} manifolds 210, 230 of an example nuclear-spin 3/2 atomic object, including the hyperfine structure. The qubit space 215 includes the m=0 states of the ground state or S_{1/2} manifold 210, which are first-order insensitive to small magnetic fields, naturally giving the states relatively long coherence times. In various embodiments, shelving operations may be performed on one and/or both qubit states using direct single photon transitions and/or other transitions excited by shelving signals 201, 202, 203, or 204, which couple the two qubit states to one or more shelving state(s) 230 to perform the operation.

Various embodiments provide a leakage error detection operation that uses a shelving and de-shelving scheme to detect a leakage error while protecting the qubit levels in the qubit space 215. For example, a leakage errors detection operation may couple the one or more atomic objects within the particular region of the apparatus that are in a qubit space of a ground state manifold to a shelved manifold and to suppress excitation of atomic objects within the particular region of the apparatus that have leaked out of the qubit space to form a leaked state. In an example embodiment, atomic objects in a first qubit state of the qubit space are coupled and/or excited to a first shelved manifold and the atomic objects in a second qubit state of the qubit space are coupled and/or excited to a second shelved manifold.

For example, a first manipulation beam, pulse, and/or set of pulses (e.g., laser beam, pulse, and/or set of pulses; referred to herein as the first manipulation beam) that is incident on one or more atomic objects within the apparatus 50 and that addresses the one or more atomic objects within the particular region of the apparatus that are in a qubit space of a ground state manifold may be provided. In an example embodiment, the first manipulation beam is a laser. The first manipulation beam may be configured to address the one or more atomic objects within the particular region of the apparatus that are in a qubit space of a ground state manifold (e.g., atomic objects in the qubit space of F=1, m=0, ²S_{1/2} states or F=2, m=0, ²S_{1/2} states) while not addressing atomic objects in the leaked states (e.g., atomic objects in the F=1, m=−1 or 1, ²S_{1/2} state or F=2, m=−2, −1, 1, or 2, ²S_{1/2} state). For example, the first manipulation beam may comprise one or more shelving signals 201, 202, 203, 204) configured to excite a transition from the qubit space of the ground state manifold 210 to respective states of a shelving manifold 230. For example, the first manipulation beam may be tuned to be resonant with transitions from the qubit space of the ground state manifold (e.g., atomic objects in the qubit space of F=1, m=0, ²S_{1/2} states or F=2, m=0, ²S_{1/2} states)) to a shelving manifold 230.

In various embodiments, the first manipulation beam may include a plurality of laser pulses to stimulate the transitions from the qubit space of the ground state manifold to the shelving manifold (e.g., via shelving signals 201, 202, 203, or 204). The first manipulation beam may be tuned to excite F=1, m=0, ²S_{1/2} state 212 (e.g., the |0>state) to F=3, m=2, ²D_{5/2} state or F=3, m=−2, ²D_{5/2} state as shown in FIG. 2A. The first manipulation beam may be further tuned to excite F=2, m=0, ²S_{1/2} state 214 (e.g., the |1>state) to F=2, m=2, ²D_{5/2} state or F=2, m=−2, ²D_{5/2} state. In various embodiments, the first manipulation beam may include a laser beam with a wavelength at 1762 nm and the laser beam span the S-state hyperfine. For example, the two qubit states of the qubit space 215 are separated by an energy difference corresponding to a frequency difference of 12 GHZ, in an example embodiment, or 8 GHZ, in another example embodiment. In various embodiments, the frequency difference between the two qubits states of the qubit space 215 is in the range of 5-20 GHZ.

In various embodiments, the first manipulation beam is configured to drive |Δm|=2 transitions and to suppress |Δm|=0 or 1 transitions. For example, the wave vector (e.g., k vector or direction of propagation) of the first manipulation beam and the polarization (e.g., electrical oscillations) of the first manipulation beam (e.g., when the first manipulation beam interacts with an atomic object) may be set to be orthogonal to the magnetic field at the location where the first manipulation beam interacts with an atomic object. For example, in an example embodiment, the wave vector of the first manipulation beam is in a first direction, the polarization of the first manipulation beam is in a second direction, and the magnetic field at the location of the atomic object is in a third direction. The first manipulation beam may be configured such that both the first and second directions are perpendicular to the third direction. Thus, the first manipulation beam may be used to pump the qubit states in the qubit space of the ground state manifold to the shelving manifold 230 while not causing leaked states to be pumped out of the ground state manifold.

In various embodiments, the laser beam of the first manipulation beam cannot span the S-state hyperfine (e.g., a frequency range of 5-20 GHZ, in various embodiments), the first manipulation beam may include a microwave pulse, a laser induced Raman transition, and/or the like configured to couple qubit levels within the qubit space. As shown in FIG. 2B, a microwave pulse may stimulate a transition 206, which couples the one or more atomic objects within the particular region of the apparatus that are in a qubit space of a ground state manifold. For example, atomic objects in a first qubit state (e.g., F=2, m=0, ²S_{1/2} state) may be coupled and/or excited to a second qubit state (e.g., F=1, m=0, ²S_{1/2} states) such that the quantum state of the atomic object evolves from the first qubit state (e.g., at F=2, m=0, ²S_{1/2} state) back into the second qubit state (e.g., F=1, m=0, ²S_{1/2} states). In particular, the microwave pulse may take a form a high-fidelity square x pulse. The first manipulation beam may further include a plurality of laser pulses to stimulate the transitions from the second qubit state of the ground state manifold to the shelving manifold (e.g., via shelving signals 203, 204, 205, or 206). The first manipulation beam may be tuned to excite F=2, m=0, ²S_{1/2} state 214 (e.g., the |1>state) to F=2, m=2, ²D_{5/2} state, F=2, m=−2, ²D_{5/2} state, F=3, m=2, ²D_{5/2} state or F=3, m=−2, ²D_{5/2} state.

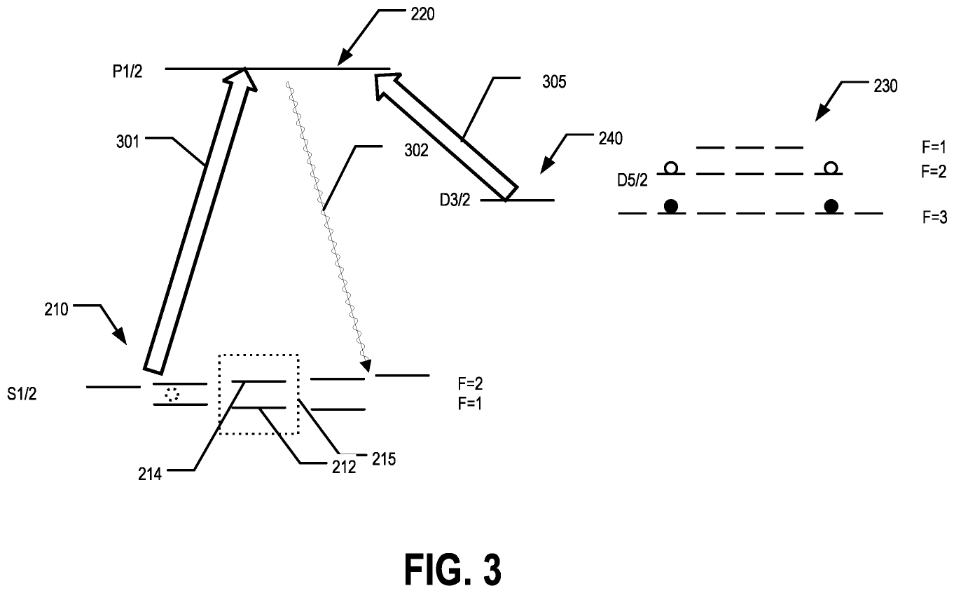

In various embodiments, a second manipulation beam, pulse, and/or set of pulses (e.g., laser beam, pulse, and/or set of pulses; referred to as the second manipulation beam herein) that is incident on one or more atomic objects within the apparatus 50 and address the atomic objects that are in a ground state manifold may be provided. In an example embodiment, the second manipulation beam comprises a first detection signal 301. In various embodiments, the first detection signal 301 is a laser beam. FIG. 3 provides a schematic illustration of applying the laser beam to the atomic objects in the particular region of the apparatus 50 to perform a detection operation. For example, as shown in FIG. 3, the detection operation may excite the one or more atomic objects within the particular region of the apparatus that have leaked out of the qubit space to form a leaked state to states of a first intermediary manifold 220, where the first intermediary manifold 220 is the ²P_{1/2} manifold. The second manipulation beam may be configured to address the one or more atomic objects within the particular region of the apparatus that have leaked out of the qubit space to form a leaked state (e.g., atomic objects in the leaked state of F=1, m=1, ²S_{1/2} states, F=1, m=−1, ²S_{1/2} states, F=2, m=2, ²S_{1/2} states, F=2, m=1, ²S_{1/2} states F=2, m=−1, ²S_{1/2} states, or F=2, m=−2, ²S_{1/2} states) while the qubit states in the qubit space of a ground state manifold (e.g., atomic objects in the qubit space of F=1, m=0, ²S_{1/2} states or F=2, m=0, ²S_{1/2} states) are shelved to the shelving manifold 230.

For example, the second manipulation beam may comprise a first detection signal 301 configured to excite atomic objects from the leaked states of the ground state manifold 210 to the first intermediary manifold 220. In an example embodiment, the second manipulation beam is configured to cause a single photon excitation of an atomic object in a leaked state (e.g., an atomic object remaining in the ground state manifold 210 (or a second intermediary manifold 240) after the shelving procedure is performed). For example, the second manipulation beam may be tuned to be resonant with transitions from the leaked states of the ground state manifold 210 to the first intermediary manifold 220.

In an example embodiment, the second manipulation beam further comprises a second detection signal 305. In various embodiments, the second detection signal is configured to excite atomic objects from a second intermediary manifold 240 (e.g., the D_{3/2} manifold in the illustrated example) to the first intermediary manifold 220. For example, the use of the second detection signal 305 enables identification of atomic object that has leaked to a state in the second intermediary manifold 240.

In various embodiments, the atomic objects in the first intermediary manifold 220 are allowed to decay into the ground state manifold 210. In various embodiments, the lifetime of the excited states of the first intermediary manifold 220 are relatively short (e.g., in a range of 1-100 ns). When the atomic objects decay from one of the states of the first intermediary manifold 220 into the ground state manifold 210 one or more photons are released, resulting in fluorescence 302. The fluorescence 302 caused by the photons may be detected by a photon detector. In various embodiments, a presence of the fluoresce indicates leaked errors occurred.

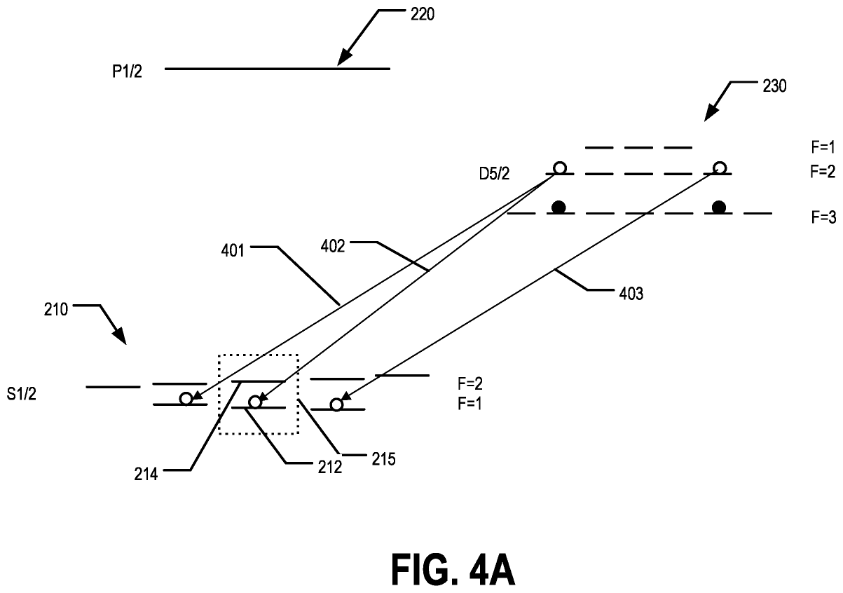

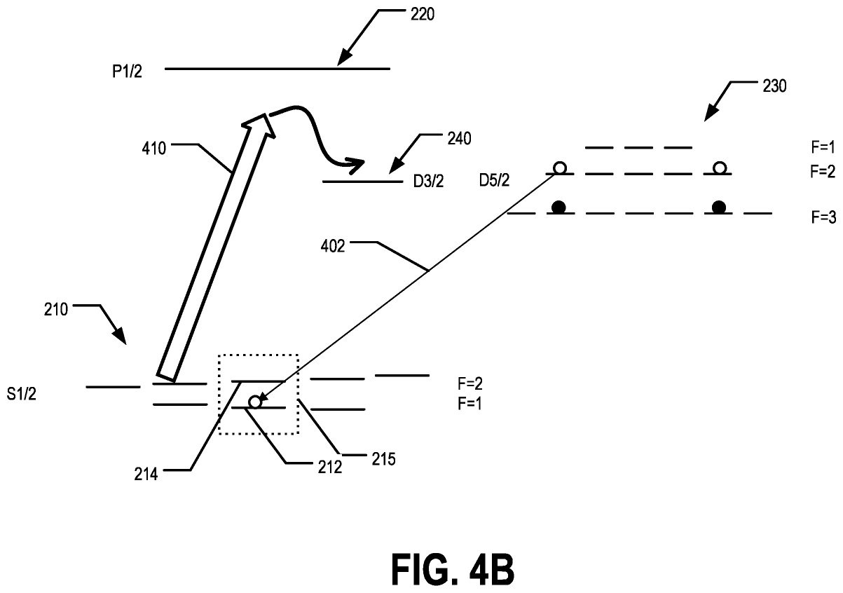

Then a third manipulation beam, pulse, and/or set of pulses (e.g., laser beam, pulse, and/or set of pulses; referred to as the third manipulation beam herein) that is incident on one or more atomic objects within the apparatus 50 and address the atomic objects that are in the shelving manifold 230 may be provided. FIG. 4A and 4B illustrate a portion of an energy level diagram for an example atomic object that may be used as a qubit of the quantum computing system, in an example embodiment. When a qubit is shelved, the qubit is transitioned to a stable state in the shelving manifold 230. To de-shelve one of the qubit states and bring the qubit state back into the ground state manifold 210, a de-shelving procedure is performed.

In various embodiments, the third manipulation beam comprises a laser beam with a wavelength at 1762 nm and the laser beam spans the S-state hyperfine frequency/energy difference (e.g., has a line width broad enough to span the frequency difference between states of the ground state manifold 210 caused by the hyperfine splitting). In various embodiments, as shown in FIG. 4A, the third manipulation beam may include two pulses 401 and 402 incident on an atomic object and configured to couple the first shelved state (e.g., at F=2, m=−2, ²D_{5/2} state) to the ground state manifold such that the quantum state of the atomic object evolves from the first shelved state (e.g., at F=2, m=−2, ²D_{5/2} state) back into the ground state manifold 210 (e.g., F=1, m=0, ²S_{1/2} state or F=1, m=−1, ²S_{1/2} state). The third manipulation beam may further include a third pulse 403 incident on the first shelved state (e.g., at F=2, m=2, ²D_{5/2} state) and couple the first shelved state (e.g., at F=2, m=2, ²D_{5/2} state) with the ground state manifold 210 (e.g., F=1, m=1, ²S_{1/2} state) such that the quantum state of the atomic object evolves from the first shelved state (e.g., at F=2, m =2, ²D_{5/2} state) back into the ground state manifold 210 (e.g., F=1, m=1, ²S_{1/2} state).

In various embodiments, as shown in FIG. 4B, the third manipulation beam may include a pulse 402 incident on a first shelved state (e.g., F=2, m=−2, ²D_{5/2} state) and couple the first shelved state (e.g., F=2, m=−2, ²D_{5/2} state) with the ground state manifold 210 (e.g., F=1, m=0, ²S_{1/2} state). In various embodiments, the third manipulation beam may further comprise a secondary excitation signal 410. For example, in various embodiments, the secondary excitation signal 410 removes deshelved atomic objects from the ground state manifold 210 (e.g., transfers them to the second intermediary manifold 240) so that atomic objects that have been deshelved by an earlier application of the deshelving pulse 402 is not transferred back to a shelved state, for example, by the repeated application of the deshelving pulse 402.

For example, the third manipulation beam comprises a first beam of a first wavelength (substantially equal to 1762 nm, in an example embodiment), such as deshelving pulse 402. The deshelving pulse 402 is configured to cause an atomic object in a shelved state of the shelving manifold 230 to be transferred to a state in the ground state manifold 210. The third manipulation signal further comprises a second beam of a second wavelength (substantially equal to 493 nm, in an example embodiment) configured to transfer any population in the ground state manifold 210 to a second intermediary manifold 240.

In various embodiments, the first and second beams may be applied simultaneously and/or at the same time, at overlapping times, and/or at alternating times. In an example embodiment, the first beam is applied and then, after the first beam has completed being incident on the atomic object, the second beam is applied. In various embodiments, the first beam couples the qubit state in the ground state manifold 210 (e.g., F=1, m=0, ²S_{1/2} state or F=1, m=−1, ²S_{1/2} state) to the first intermediary manifold 220 (e.g., P_{1/2} manifold). In various embodiments, the second beam couples the qubit state in the first intermediary manifold 220 (e.g., P_{1/2} manifold) to a second intermediary manifold 240 (e.g., D_{3/2} manifold). In various embodiments, the process of applying third manipulation beam to cause the atomic objects to transition from the first shelved state (e.g., F=2, m=−2, ²D_{5/2} state) to the ground state manifold 210 and cause the atomic objects in the ground state manifold 210 to transition to the second intermediary manifold 240 may be repeated for a plurality of cycles. For example, the process may be repeated for 2 cycles. For example, the process may be repeated for more cycles to improve the de-shelving fidelities.

In various embodiments, the process of applying third manipulation beam may be further performed to cause the atomic objects to transition from the first shelved state (e.g., F=2, m=2, ²D_{5/2} state) to the ground state manifold 210 and to cause the atomic objects in the ground state manifold 210 to transition to the second intermediary manifold 240.

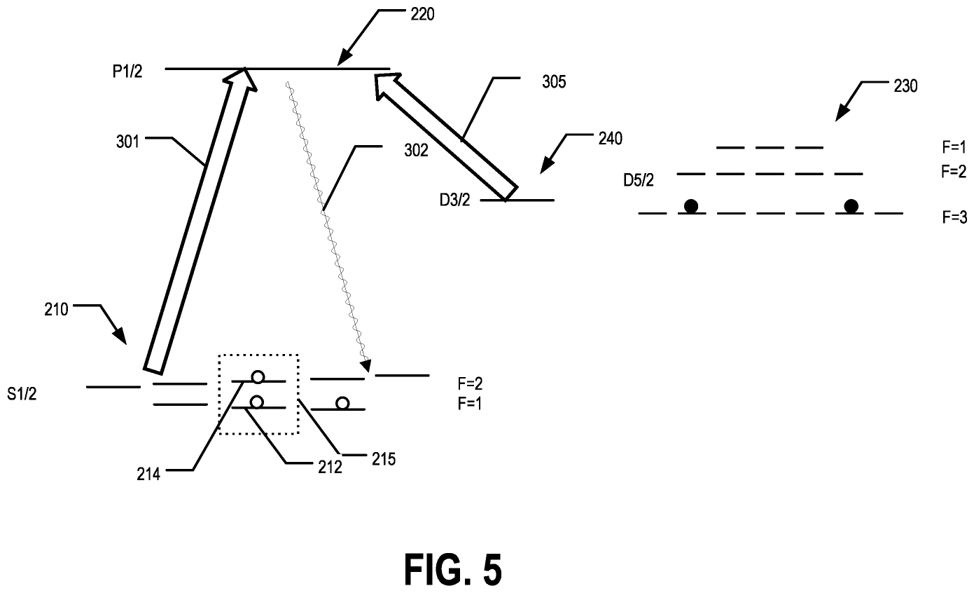

Then a second manipulation beam, pulse, and/or set of pulses (e.g., laser beam, pulse, and/or set of pulses; referred to as the second manipulation beam herein) that is incident on one or more atomic objects within the apparatus 50 and detect the qubit state of the atomic objects that are in a ground state manifold 210 or the second intermediary manifold 240 may be provided. As shown in FIG. 5, a detection operation is performed by applying the second manipulation beam to the atomic objects in the particular region of the apparatus 50.

For example, the second manipulation beam comprises a first detection signal 301 configured to excite atomic objects from the ground state manifold 210 to the first intermediary manifold 220, in an example embodiment. In an example embodiment, the second manipulation beam is configured to cause a single photon excitation of an atomic object in the ground state manifold 210 (or a second intermediary manifold 240) after the shelving procedure is performed. For example, the second manipulation beam may be tuned to be resonant with transitions from the states of the ground state manifold 210 to the first intermediary manifold 220.

In an example embodiment, the second manipulation beam further comprises a second detection signal 305. In various embodiments, the second detection signal is configured to excite atomic objects from a second intermediary manifold 240 (e.g., the D_{3/2} manifold in the illustrated example) to the first intermediary manifold 220. For example, the use of the second detection signal 305 enables identification of an atomic object that has been deshelved to a state in the second intermediary manifold 240.

In an example embodiment, the second manipulation beam comprises a first detection signal 301. In various embodiments, the first detection signal 301 is a laser beam with a wavelength substantially equal to 493 nm to detect qubit state in the ground state manifold 210. In an example embodiment, the second manipulation beam further comprises a second detection signal 305. In various embodiments, the second detection signal 305 is a laser beam with a wavelength substantially equal to 650 nm to detect qubit state in the second intermediary manifold 240.

In various embodiments, the shelved qubit states are de-shelved by coupling the shelved states back to one or more states of a ground state manifold or an intermediary state manifold. A detection operation may be performed to determine qubit states of the atomic objects.

### Exemplary Operation of a Leakage Errors Detection Operation

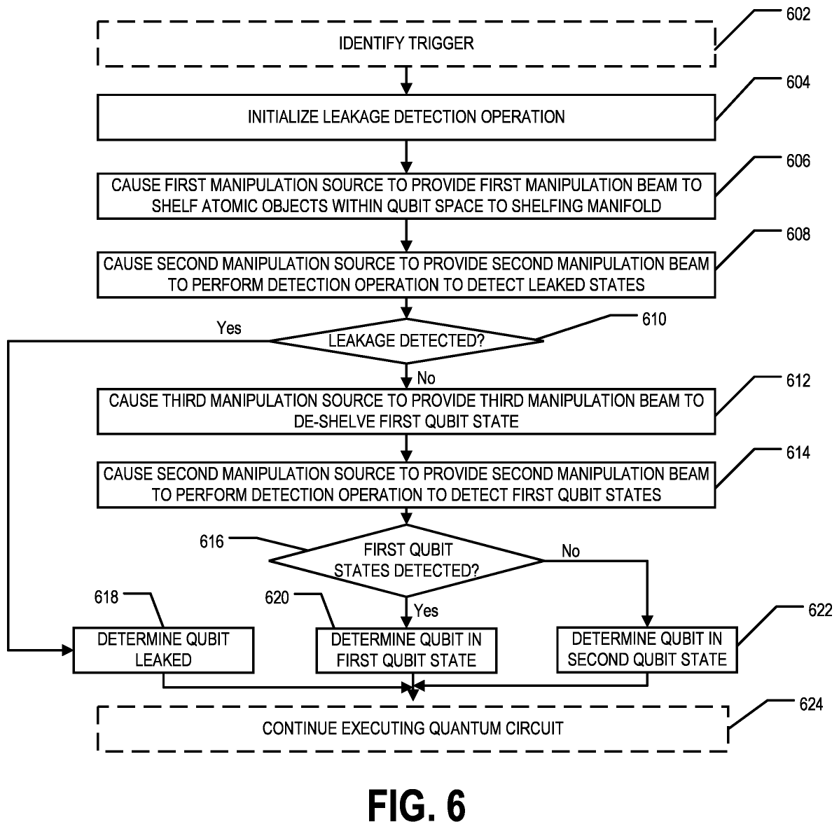

FIG. 6 provides a flowchart illustrating processes, procedures, operations, and/or the like performed to detect leakage errors in hyperfine qubits by shelving and protecting qubit levels. For example, both hyperfine qubit levels of the ground level may be excited and shelved to long-lived meta-stable states of a shelving manifold that do not participate in the detection cycle and population in the non-qubit levels are not affected by the shelving. In various embodiments, a quantum computer 110 may comprise a plurality of atomic objects (e.g., trapped within an apparatus 50). The hyperfine levels of the atomic objects may be used define a qubit space 215. For example, the atomic objects may be nuclear-spin 3/2 atomic objects and the hyperfine structure of the ground state (e.g., the ²S_{1/2} manifold) may be used to define a qubit space 215 (e.g., comprising F=1, m=0, ²S_{1/2} states and F=2, m=0, ²S_{1/2} states). In various scenarios, an atomic object may leak out of the qubit space 215. For example, an atomic object may experience a spontaneous emission event or other excitation event and end up in a leaked state (e.g., one of the F=1, m=−1 or 1, ²S_{1/2} state or F=2, m=−2, −1, 1, or 2, ²S_{1/2} state). A leakage errors detection operation may be used to detect the atomic objects in the leaked states.

Starting at step/operation 602, a leakage errors detection operation trigger is identified. In various embodiments, the trigger is the performance of a computing operation, performance of a computing operation of a particular type, a set amount of time elapsing since a leakage errors detection operation was last performed, and/or the like. For example, the types of computing operations may include gate operations, cooling operations, transport operations, qubit interaction operations, qubit measurement operations, and/or the like. For example, the controller 30 may schedule one or more computing operations based on a received quantum algorithm or quantum circuit (e.g., provided by a computing entity 10). Based on the scheduling of an operation that is identified as a trigger, the controller 30 may schedule the performance of a leakage errors detection operation. For example, the scheduling of a reading/detection operation in a particular region of the apparatus 50, in accordance with a quantum algorithm and/or quantum circuit being and/or to be performed by the quantum computer 110, may be identified as a trigger. For example, the scheduling and/or performance of a gate operation in a particular region of the apparatus 50, in accordance with a quantum algorithm and/or quantum circuit being and/or to be performed by the quantum computer 110, may be identified as a trigger.

Responsive to identifying the scheduling and/or performance of the gate operation in the particular region of the apparatus 50, the controller 30 may schedule and/or perform a leakage errors detection operation to be performed in the particular region of the apparatus 50. For example, the operation that triggered the scheduling/performance of the leakage errors detection operation may address one or more atomic objects located in the particular region of the apparatus 50 and the leakage errors detection operation may be configured to address the one or more atomic objects located in the particular region of the apparatus 50.

In an example embodiment, the computing entity 10 may provide a quantum algorithm and/or quantum circuit. The controller 30 may receive the quantum algorithm and/or quantum circuit and schedule and/or perform one or more operations (e.g., computing operations such as gate operations, cooling operations, transport operations, qubit interaction operations, qubit measurement operations; leakage errors detection operations; and/or the like). In an example embodiment, the quantum algorithm and/or quantum circuit may indicate when a leakage errors detection operation is to be performed. In an example embodiment, the controller 30 may determine when to perform a leakage errors detection operation based on the computing operations of the quantum algorithm and/or quantum circuit.

At step/operation 604, the leakage errors detection operation may be initiated. For example, controller 30 may initiate the leakage errors detection operation. For example, responsive to identifying the trigger, the controller 30 may schedule the performance of a leakage errors detection operation and/or cause a leakage errors detection operation to be performed (e.g., at a particular time and/or in a particular position in a sequence of operations performed by the quantum computer 110).

At step/operation 606, the controller 30 may cause a first manipulation source 64A to provide a first manipulation beam, pulse, and/or set of pulses (e.g., laser beam, pulse, and/or set of pulses; referred to herein as the first manipulation signal) that is incident on one or more atomic objects within the apparatus 50 and that addresses the one or more atomic objects within the particular region of the apparatus that are in a qubit space of a ground state manifold. In an example embodiment, the first manipulation source 64A is a laser. The first manipulation beam may be configured to address the one or more atomic objects within the particular region of the apparatus that are in a qubit space of a ground state manifold (e.g., atomic objects in the qubit space of F=1, m=0, ²S_{1/2} states or F=2, m=0, ²S_{1/2} states) while not addressing atomic objects in the leaked states (e.g., atomic objects in the F=1, m=−1 or 1, ²S_{1/2} state or F=2, m=−2, −1, 1, or 2, ²S_{1/2} state). For example, the first manipulation beam may comprise one or more shelving signals 201, 202, 203, 204) configured to excite a transition from the qubit space of the ground state manifold 210 to respective states of a shelving manifold 230. For example, the first manipulation beam may be tuned to be resonant with transitions from the qubit space of the ground state manifold (e.g., atomic objects in the qubit space of F=1, m=0, ²S_{1/2} states or F=2, m=0, ²S_{1/2} states)) to a shelving manifold 230.

In various embodiments, the first manipulation beam may include a plurality of laser pulses to stimulate the transitions from the qubit space of the ground state manifold to the shelving manifold (e.g., via shelving signals 201, 202, 203, or 204). The first manipulation beam may be tuned to excite F=1, m=0, ²S_{1/2} state 212 (e.g., the |0>state) to F=3, m=2, ²D_{5/2} state or F=3, m=−2, ²D_{5/2} state as shown in FIG. 2A. The first manipulation beam may be further tuned to excite F=2, m=0, ²S_{1/2} state 214 (e.g., the |1>state) to F=2, m=2, ₂D_{5/2} state or F=2, m=−2, ²D_{5/2} state.

Continuing with FIG. 6, to step/operation 608 , the controller 30 may cause a second manipulation source 64B to provide a second manipulation beam, pulse, and/or set of pulses (e.g., laser beam, pulse, and/or set of pulses; referred to as the second manipulation signal herein) that is incident on one or more atomic objects within the apparatus 50 and detect the atomic objects that are in a leaked state of the ground state manifold. In an example embodiment, the second manipulation source 64B is and/or includes a laser. For example, the detection operation may excite the one or more atomic objects within the particular region of the apparatus that have leaked out of the qubit space to form a leaked state to states of a first intermediary manifold 220, where the first intermediary manifold 220 is the ²P_{1/2} manifold. The second manipulation signal may be configured to address the one or more atomic objects within the particular region of the apparatus that have leaked out of the qubit space to form a leaked state (e.g., atomic objects in the leaked state of F=1, m=1, ²S_{1/2} states, F=1, m=−1, ²S_{1/2} states, F=2, m=2, ²S_{1/2} states, F=2, m=1, ²S_{1/2} states F=2, m=−1, ²S_{1/2} states, or F=2, m=−2, ²S_{1/2} states). In an example embodiment, the second manipulation signal is configured to address the one or more atomic objects within the particular region of the apparatus 50 that are still present in the ground state manifold after performance of the shelving operation (e.g., application of the first manipulation signal(s)).

In various embodiments, the atomic objects in the first intermediary manifold 220 are allowed to decay into the ground state manifold 210. In various embodiments, the lifetime of the excited states of the first intermediary manifold 220 are relatively short (e.g., in a range of 1-100 ns). When the atomic objects decay from one of the states of the first intermediary manifold 220 into the ground state manifold 210 one or more photons are released, resulting in fluorescence 302. The fluorescence 302 caused by the photons may be detected by a photon detector. In various embodiments, a presence of the fluoresce indicates leaked errors occurred. For example, a photon detector of the optics collection system 68 may detect the photon emitted by the atomic object and provide a corresponding photon detector signal to the controller 30. The photon detector signal is an electric signal, in various embodiments, with an amplitude that indicates the intensity of light and/or number of photons detected. As a result of processing the photon detector signal, the controller 30 may determine that an atomic object in a leaked state was detected. In an instance where the optics collection system does not detect any photons emitted by the atomic object, when the controller processes the corresponding photon detector signal provided to the controller 30 by the optics collection system and determines, based thereon, that no atomic object in a leaked state was detected.

At step/operation 610, the controller 30 determines if leaked errors occurred. For example, the controller 30 may be configured and/or programmed to execute in response to the detection results of the leaked errors.

When, at step/operation 610, the controller 30 determines that leaked errors have occurred, the process go to step/operation 618 and determines that qubit has leaked. When, at step/operation 610, the controller 30 determines that the leaked errors have not occurred, the process continues to step/operation 612.

Continuing with FIG. 6, at step/operation 612, the controller 30 may cause a third manipulation source 64C to provide a third manipulation beam, pulse, and/or set of pulses (e.g., laser beam, pulse, and/or set of pulses; referred to as the third manipulation signal herein) that is incident on one or more atomic objects within the apparatus 50 and address the atomic objects that are in the shelving manifold 230. To de-shelve first shelved qubit states and bring the first shelved qubit state back into the ground state manifold 210, a de-shelving procedure is performed.

In various embodiments, the third manipulation beam may couple the first shelved states (e.g., at F=2, m=2, ²D_{5/2} state and F=2, m=−2, ²D_{5/2} state)) with the ground state manifold 210 (e.g., F=1, m=1, ²S_{1/2} state). In various embodiments, the third manipulation beam may couple the first shelved states (e.g., at F=2, m=2, ²D_{5/2} state and F=2, m=−2, ²D_{5/2} state)) with a second intermediary manifold 240 through the ground state manifold 210 (e.g., F=1, m=1, ²S_{1/2} state) and a first intermediary manifold 220.

Continuing with FIG. 6, at step/operation 614, the controller 30 may then cause the second manipulation source 64B to provide a second manipulation beam, pulse, and/or set of pulses (e.g., laser beam, pulse, and/or set of pulses; referred to as the second manipulation signal herein) that is incident on one or more atomic objects within the apparatus 50 and perform a detection operation to detect the qubit state of the atomic objects that are in a ground state manifold 210 or the second intermediary manifold 240. The detection operation is performed by applying the laser beam to the atomic objects in the particular region of the apparatus 50. In an example embodiment, the second manipulation source 64B may a laser with a first wavelength substantially equal to 493 nm to detect qubit state in the ground state manifold 210. In an example embodiment, the second manipulation source 64B may a laser with a first wavelength substantially equal to 650 nm to detect qubit state in the second intermediary manifold 240.

At step/operation 616, the controller 30 determines if first qubit states are presented. For example, the controller 30 may be configured and/or programmed to execute in response to the detection results of the first qubit states.

When, at step/operation 616, the controller 30 determines that the first qubit state is presented, the process go to step/operation 620 and determines that the qubit is in the first qubit state. When, at step/operation 616, the controller 30 determines that the first qubit state is presented, the process continues to step/operation 622 and determines that the qubit is in the second qubit state.

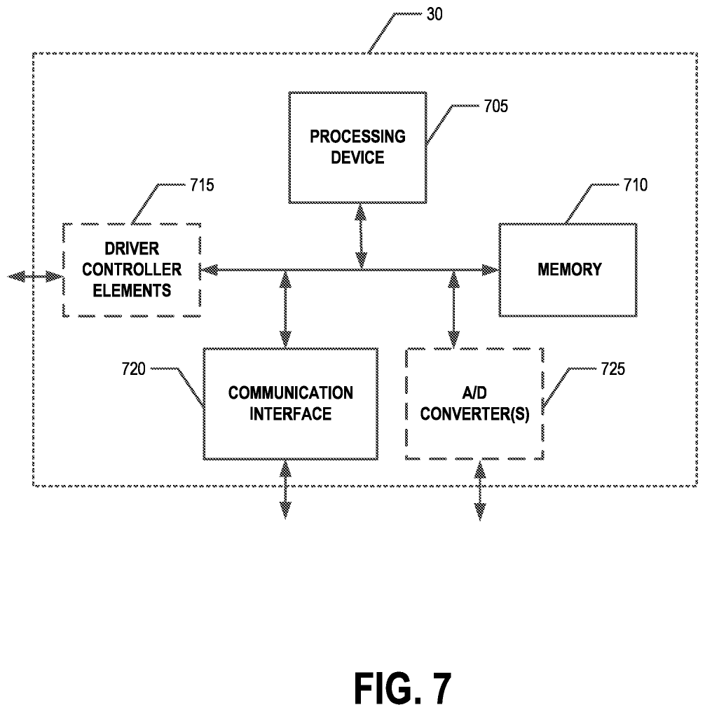

Returning to FIG. 6, at step/operation 624, the controller 30 the controller 30 may cause the quantum computer to continue executing the remainder and/or another portion of the quantum algorithm and/or circuit according to status of the qubit states. For example, the controller 30 may comprise means, such as processing device 705, memory 710, driver controller elements 715, A/D converter(s) 725, and/or the like (see FIG. 7), for executing an additional and/or remaining portion of the quantum algorithm and/or circuit. For example, the controller 30 may continue to execute the queue of commands to cause the additional and/or remaining portion of the quantum algorithm and/or circuit to be executed. For example, executing the additional and/or remaining portion of the quantum algorithm and/or circuit may comprise initializing one or more qubits (e.g., placing one or more atomic objects into the qubit space 215), transporting at least some of the one or more qubits to one or more particular locations within the atomic object confinement apparatus 300, performing one or more one and/or two and/or multi-qubit gates on at least some of the one or more qubits, detecting at least some of the one or more qubits, and/or the like. In an example embodiment, the additional and/or remaining portion of the quantum algorithm and/or circuit may be modified based on the quantum state of the qubit determined at step/operation 608.

### Technical Advantages

In various embodiments, a two-state qubit space is defined. In various embodiments, a qubit is an atomic object contained, trapped, and/or otherwise within an apparatus of a quantum computer. The atomic object contained, trapped, and/or otherwise within the apparatus 50 may have access to more quantum states than those of the qubit space. For example, when the atomic object is a nuclear-spin 3/2 atomic object, the ground state manifold of the atomic object may comprise eight states (e.g., two states in the qubit space and six leaked states). Thus, as the quantum computer executes various operations, one or more atomic objects trapped in the apparatus may be leaked out of the qubit space into a leaked state. The leakage of atomic objects into leaked states results in errors in the computations performed by the quantum computer 110. For example, conventionally when an atomic object is in a leaked state, it is interpreted as being in the dark state or non-bright state of the qubit space based on a detection operation not resulting in a bright state determination. This reduces the overall fidelity of computations performed by the quantum computer.

Various embodiments provide technical solutions to these technical problems by providing techniques and corresponding apparatus and/or systems for detecting the leakage errors while shelving and protecting qubits within the qubit space. In particular, both hyperfine qubit levels of the ground level may be excited and shelved to long-lived meta-stable states of a shelving manifold that do not participate in the detection cycle and population in the non-qubit levels are not affected by the shelving. In various embodiments, laser beams are turned on to cause atomic objects at leakage states to fluoresce and a presence of the fluoresce indicates leaked errors occurred. In various embodiments, the shelved qubit state may be de-shelved and coupled to a ground state manifold or an intermediary state manifold. Detection operation may be performed to determine qubit states of the atomic objects. As such, the leakage error detection can be achieved without affecting the ability to determine qubit state. In addition, shelving errors are minimized, and high fidelities are achieved with the use of multiple shelving and de-shelving pulses.

### Exemplary Controller

In various embodiments, a quantum computer 110 further comprises a controller 30 configured to control various elements of the quantum computer 110. In various embodiments, a controller 30 may be configured to cause a quantum computer 110 to perform various operations (e.g., computing operations such as gate operations, cooling operations, transport operations, qubit interaction operations, qubit measurement operations; leakage errors detection operations; and/or the like). For example, the controller 30 may be configured to identify a trigger, schedule a leakage errors detection operation and/or cause a leakage errors detection operation to be performed, control first and/or second manipulation sources to provide first and/or second manipulation signals, and/or the like. For example, the controller 30 may be configured to control a cryogenic system and/or vacuum system controlling the temperature and pressure within the cryogenic and/or vacuum chamber 40, manipulation sources 64, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more atomic objects within the apparatus 50.

As shown in FIG. 7, in various embodiments, the controller 30 may comprise various controller elements including processing devices 705, memory 710, driver controller elements 715, a communication interface 720, analog-digital converter elements 725, and/or the like. For example, the processing devices 705 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing device 705 of the controller 30 comprises a clock and/or is in communication with a clock.

For example, the memory 710 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 710 may store qubit records corresponding to the qubits of the quantum computer (e.g., in a qubit record data store, qubit record database, qubit record table, and/or the like), a calibration table, an executable queue, computer program code (e.g., in a one or more computer languages, specialized controller language(s), and/or the like), and/or the like. In an example embodiment, execution of at least a portion of the computer program code stored in the memory 710 (e.g., by a processing device 705) causes the controller 30 to perform one or more steps, operations, processes, procedures and/or the like described herein.

In various embodiments, the driver controller elements 715 may include one or more drivers and/or controller elements each configured to control one or more drivers. In various embodiments, the driver controller elements 715 may comprise drivers and/or driver controllers. For example, the driver controllers may be configured to cause one or more corresponding drivers to be operated in accordance with executable instructions, commands, and/or the like scheduled and executed by the controller 30 (e.g., by the processing device 705). In various embodiments, the driver controller elements 715 may enable the controller 30 to operate a manipulation sources 64, operate vacuum and/or cryogenic systems, and/or the like. In various embodiments, the drivers may be laser drivers; vacuum component drivers; cryogenic and/or vacuum system component drivers; and/or the like. In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter elements 725 configured to receive signals from one or more optical receiver components, calibration sensors, and/or the like.

In various embodiments, the controller 30 may comprise a communication interface 720 for interfacing and/or communicating with a computing entity 10. For example, the controller 30 may comprise a communication interface 720 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or one or more wired and/or wireless networks 20.

### Exemplary Computing Entity

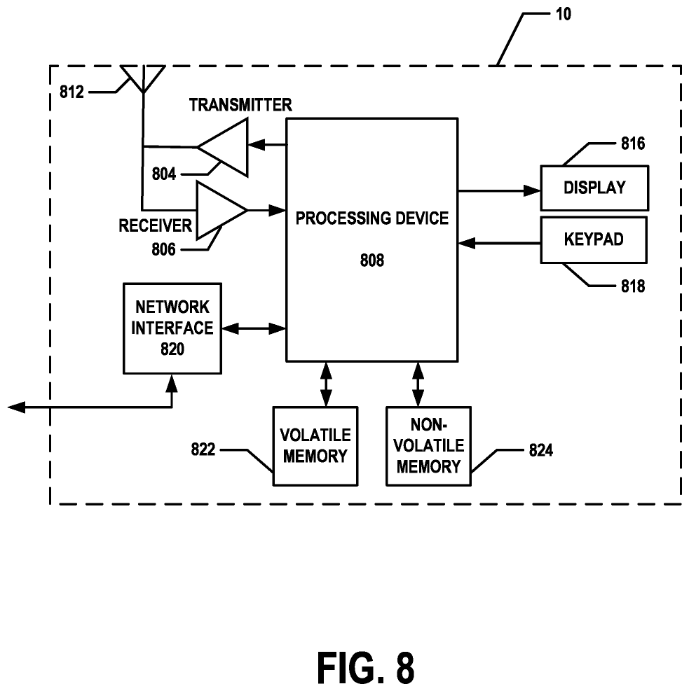

FIG. 8 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110. For example, a user may operate a computing entity 10 to generate and/or program a quantum algorithm and/or quantum circuit that may be provided such that the controller 30 may receive the quantum algorithm and/or quantum circuit and cause the quantum computer 110 to perform the quantum algorithm and/or quantum circuit.

As shown in FIG. 8, a computing entity 10 can include an antenna 812, a transmitter 814 (e.g., radio), a receiver 806 (e.g., radio), and a processing device 808 that provides signals to and receives signals from the transmitter 814 and receiver 806, respectively. The signals provided to and received from the transmitter 814 and the receiver 806, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system. In various embodiments, the computing entity 10 comprises a network interface 820 configured for communicating via one or more wired and/or wireless networks 20.

The computing entity 10 may also comprise a user interface device comprising one or more user input/output interfaces (e.g., a display 816 and/or speaker/speaker driver coupled to a processing device 808 and a touch screen, keyboard, mouse, and/or microphone coupled to a processing device 808). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 818 (hard or soft), a touch display, voice/speech or motion interfaces, scanners, readers, or other input device. In embodiments including a keypad 818, the keypad 818 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 822 and/or non-volatile storage or memory 824, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for detecting leakage errors in a quantum system, the method comprising:
causing, by a controller of the quantum system, a first manipulation source to provide a first manipulation signal to a particular region of an apparatus of the quantum system having one or more atomic objects confined therein, wherein the first manipulation signal is tuned to excite the one or more atomic objects within the particular region of the apparatus that are in a qubit space of a ground state manifold to a shelving manifold and to suppress excitation of atomic objects within the particular region of the apparatus that have leaked out of the qubit space into leaked states;
causing, by the controller of the quantum system, a second manipulation source to provide a second manipulation signal to perform a detection operation on the one or more atomic objects; and
determining, by the controller of the quantum system, if leakage errors have occurred based on a signal generated as part of the detection operation.

2. The method of claim 1, wherein the first manipulation signal includes at least two shelving pulses to excite the one or more atomic objects within the particular region of the apparatus that are in the qubit space to the shelving manifold.

3. The method of claim 2, wherein the first manipulation signal further includes a microwave pulse to couple qubit states within the qubit space.

4. The method of claim 1, wherein the qubit space of the ground state manifold includes a first qubit state and a second qubit state.

5. The method of claim 4, in response to the leakage errors not being detected, further comprising:
causing, by the controller of the quantum system, a third manipulation source to provide a third manipulation signal to the particular region of the apparatus, wherein the third manipulation signal is tuned to de-shelve the first qubit state from the shelving manifold to the ground state manifold or an intermediary state manifold.

6. The method of claim 5, wherein:
the controller of the quantum system is further configured to determine if the one or more atomic objects are in the first qubit states in the ground state manifold or the intermediary state manifold based on a signal of the detection operation.

7. The method of claim 6, wherein:
the controller of the quantum system is further configured to determine if the one or more atomic objects are in the second qubit states in the shelving manifold based on a signal of the detection operation.

8. The method of claim 6, wherein the one or more atomic objects are nuclear-spin 3/2 atomic objects, the ground state manifold is a ²P_{1/2} manifold, the intermediary state manifold is a ²D_{3/2} manifold, and the shelving manifold is a ²D_{5/2} manifold.

9. The method of claim 1, wherein the qubit space is defined based on hyperfine structure of a ground state manifold of the one or more atomic objects.

10. The method of claim 1, wherein each of the one or more atomic objects has a spin 3/2 nucleus.

11. A quantum system comprising:
an apparatus having one or more atomic objects confined thereby;
a first manipulation source configured to provide a first manipulation signal;
a second manipulation source configured to provide a second manipulation signal; and
a controller, the controller configured to:
cause the first manipulation source to provide the first manipulation signal to a particular region of the apparatus, wherein the first manipulation signal is tuned to excite the one or more atomic objects confined within the particular region of the apparatus that are in a qubit space of a ground state manifold to a shelving manifold and to suppress excitation of atomic objects within the particular region of the apparatus that have leaked out of the qubit space into leaked states;
cause the second manipulation source to provide the second manipulation signal to perform a detection operation on the one or more atomic objects; and
determine if leakage errors have occurred based on a signal of the detection operation.

12. The quantum system of claim 11, wherein the first manipulation signal includes at least two shelving pulses to excite the one or more atomic objects within the particular region of the apparatus that are in the qubit space to the shelving manifold.

13. The quantum system of claim 12, wherein the first manipulation signal further includes a microwave pulse to couple qubit states within the qubit space.

14. The quantum system of claim 11, wherein the qubit space of the ground state manifold includes a first qubit state and a second qubit state.

15. The quantum system of claim 14, wherein in response to the leakage errors not being detected, the controller is further configured to:
cause a third manipulation source to provide a third manipulation signal to the particular region of the apparatus, wherein the third manipulation signal is tuned to de-shelve the first qubit state from the shelving manifold to the ground state manifold or an intermediary state manifold.

16. The quantum system of claim 15, wherein:
the controller of the quantum system is further configured to determine if the one or more atomic objects are in the first qubit states in the ground state manifold or the intermediary state manifold based on a signal of the detection operation.

17. The quantum system of claim 16, wherein:
the controller of the quantum system is further configured to determine if the one or more atomic objects are in the second qubit states in the shelving manifold based on a signal of the detection operation.

18. The quantum system of claim 16, wherein the one or more atomic objects are nuclear-spin 3/2 atomic objects, the ground state manifold is a ²P_{1/2} manifold, the intermediary state manifold is a ²D_{3/2} manifold, and the shelving manifold is a ₂D_{5/2} manifold.

19. The quantum system of claim 11, wherein the qubit space is defined based on hyperfine structure of a ground state manifold of the one or more atomic objects.

20. The quantum system of claim 11, wherein each of the one or more atomic objects has a spin 3/2 nucleus.

21. A method comprising:
causing performance of a detection operation on an atomic object;
determining a detected state of the atomic object, wherein the detected state of the atomic object is determined by processing one or more photon detector signals generated during performance of the detection operation and the detected state of the atomic object is determined from the group consisting of leaked state, a first qubit state, and a second qubit state.

22. A controller comprising a classical processing device and a classical memory storing executable instructions, the executable instructions configured to, when executed by the classical processing device, cause the controller to:
control one or more components of a system comprising a confinement apparatus confining one or more atomic objects to perform a detection operation on an atomic object of the one or more atomic objects; and
determine, by processing one or more photon detector signals generated during performance of the detection operation, whether the atomic object is in a leaked state, a first qubit state, or a second qubit state.

23. A system comprising:
a confinement apparatus configured to confine one or more atomic objects;
a manipulation source configured to provide a manipulation signal;
an optics collection system comprising a photon detector; and
a controller, wherein the controller is configured to control operation of the manipulation source and receive photon detector signals generated by the photon detector, wherein the controller comprises a classical processing device and a classical memory storing executable instructions, the executable instructions configured to, when executed by the classical processing device, cause the controller to:
control one or more components of a system comprising a confinement apparatus confining one or more atomic objects to perform a detection operation on an atomic object of the one or more atomic objects; and
determine, by processing one or more photon detector signals generated during performance of the detection operation, whether the atomic object is in a leaked state, a first qubit state, or a second qubit state.
